(19) United States
(12) Patent Application Publication
(10) Pub. No.: US 2002/0143415 A1
(43) Pub. Date: Oct. 3, 2002

(54) Wireless audio and data interactive system and method

(76) Inventors: William S. Buehler, Zeeland, MI (US); Harry G. Derks, Holland, MI (US); Warren Guthrie, West Olive, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/107,693

(22) Filed: Mar. 27, 2002

Related U.S. Application Data
(60) Provisional application No. 60/279,533, filed on Mar. 28, 2001.

(51) Int. Cl. G06F 17/00

(52) U.S. Cl. 700/94

(57) ABSTRACT

An audio and data interactive system and method includes at least one base unit and at least one remote unit. The at least one base unit has a first microprocessor-based control and the at least one student unit has a second microprocessor-based control, a speaker system and a wireless transceiver. The first control combines digital data with at least one audio signal within the human hearing range and supplies the combined digital data and audio signal to the first transceiver. The second control separates the combined digital data and audio signal from the second transceiver into the digital data in the audio signal. The second control supplies the audio signal to the speaker system and causes the second wireless transceiver to transmit in response to the digital data.

### CROSS-REFERENCE TO RELATED APPLICATION

This application claims priority from U.S. provisional patent application Serial No. 60/279,533, filed Mar. 28, 2001, entitled Learning Laboratory With Combined Audio and Data Channel, the disclosure of which is hereby incorporated herein by reference.

### BACKGROUND OF THE INVENTION

This invention generally relates to a wireless system in which audio is provided from one or more base unit(s) to one or more remote unit(s) for reproducing the audio and data is provided to the remote unit(s) in order to, for example, control the remote unit(s). The invention may be used in simultaneous language translation/interpretation systems, in congress voting systems, in audience response systems, in walking tour systems, in pager systems, in learning laboratories, and the like. In the case of learning laboratories, pre-recorded audio lessons may be provided to one or more students from an audio source, such as an audiotape, compact disc, VCR, computer, or the like. The audio comprises a lesson in the form of speech, music, or a combination of both, which is presented to the student, and the student responds either by repeating the material presented, by answering questions presented, or by translating languages, or the like.

Such a wireless learning laboratory includes at least one base unit, also referred to as an instructor, or monitor, unit, or console, that is linked with one or more remote units, also referred to as student units, via wireless communication. In known wireless laboratories, a communication channel is provided for each student in order to communicate pre-recorded audio lesson information to the student unit. The monitor, or instructor, is able to tap into the audio voice signal of the student, in order to monitor the student's progress, or the like. A separate intercom channel is required if the instructor/monitor wishes to carry on a two-way conversation with a particular student. In one known type of learning laboratory, a separate intercom channel is provided with each student channel. In this manner, if an instructor wishes to communicate with a student, the instructor could switch on the intercom channel associated with a student and carry on a conversation with that particular student. The providing of separate intercom channels with each student's audio channel requires precision components, which adds to the costs and complexity of the system.

In another wireless learning laboratory manufactured by the assignee, Fleetwood Group, Inc., the requirement for individual intercom channels with each student's audio channel is eliminated. A separate data channel is supplied jointly to the headsets of the students. The instructor/monitor can send a code on the data channel that causes one of the student's headsets to connect with a single intercom channel that is common to all of the students.

### SUMMARY OF THE INVENTION

The present invention provides an audio and data interactive system and method, including at least one base unit and at least one remote unit that overcome the deficiencies in the prior art. An audio and data interactive system and method, according to the invention, includes providing at least one base unit and at least one remote unit. The at least one base unit has a first microprocessor-based control and a first wireless transceiver. The at least one remote unit has a second microprocessor-based control, a speaker system and a wireless transceiver. The first control combines digital data with at least one audio signal within the human hearing range and supplies the combined digital data and audio signal to the first transceiver. The second control separates the combined data and audio signal from the second transceiver into the digital data and the audio signal.

The second control may supply the audio signal to the speaker system. The second control may control the at least one remote unit. Such control may include causing the second wireless transceiver to transmit in response to the digital data. The at least one remote unit may transmit remote unit audio in response to the digital data. The first and second transceivers may define a plurality of audio channels between the base unit and the remote units. The audio channels may provide pre-recorded materials to the remote units. The second control may connect the corresponding speaker system to one of the audio channels in response to the digital data. The first and second transceivers may define at least one intercom channel between the base unit and the remote units. The at least one intercom channel provides communication between the base unit and the remote units. The second control may connect the corresponding speaker system to the at least one intercom channel in response to the digital data.

The first and second transceivers may define at least one monitoring channel between the at least one remote unit and the at least one base unit. The monitoring channel allows the at least one base unit to monitor audio generated at the at least one remote unit.

The second control may cause the second wireless transceiver to transmit audio at the associated remote unit in response to the digital data. The base unit may include another speaker system to convert the remote unit audio generated at the remote unit to human perceptible audio. The base unit speaker system may include a headphone. The audio signal may be selected from either an output of the remote unit headphone or pre-recorded lesson material.

The second control may combine additional digital data with audio generated at the remote unit and supply the combined additional digital data and remote unit audio signal to the second transceiver. The first control may separate the combined additional digital data and remote unit audio signal from the first transceiver into the additional digital data and the remote unit audio signal. The additional digital data may include information, such as information on test performance, strength of the signal received by the student, status of operation of the student unit, or the like. The monitor unit may include another speaker system to convert the remote unit audio signal to human perceptible audio.

According to another aspect of the invention, a wireless communication link interconnects at least one base unit with at least one remote unit. The communication link is capable of combining, or multiplexing, audio and data signals. More particularly, digital data and analog audio signals can be sent from the at least one base unit on common channels to the at least one remote unit. A common channel, known as an intercom channel, can be selectively connected with one of the remote units by data sent from the base unit over the communication link to that remote unit. The digital data may also instruct the remote unit to turn its transmitter to a channel other than the intercom.

These and other objects, advantages and features of this invention will become apparent upon review of the following specification in conjunction with the drawings.

### BRIEF DESCRIPTION OF THE DRAWINGS

FIG. 1 is an electronic block diagram of a teacher/monitor control panel/console, according to the invention;

FIG. 2 is an electronic block diagram of a student unit, according to the invention;

FIGS. 3a-3f are detailed electronic schematic diagrams of a student unit, the principles disclosed therein being utilized in the teacher/monitor console, as well.

### DESCRIPTION OF THE PREFERRED EMBODIMENT

Referring now specifically to the drawings, and the illustrative embodiments depicted therein, a wireless audio and data interactive system 10 is made up of at least one base unit 12 and at least one remote unit 14. A typical system may include a base unit in communication with a plurality of remote units. There may be more than one base unit. Also, there may be only one remote unit. Indeed, there may be a single base unit communicating with a single remote unit. The base unit may be stationary, such as a podium or console, or may be portable. The remote unit is typically portable, but may be stationary as well. Interactive system 10 may be a simultaneous language translation and/or interpretation system, wherein the translation/interpretation is provided at one or more base unit(s) 12 and each remote unit 14 is capable of tuning to one of multiple different languages or interpretation channels so that each user can listen in their own language. Interactive system 10 may be a congress voting system or an audience response system, wherein each remote unit receives voting selections from a user and the selections are retrieved at the base unit. Interactive system 10 may be a walking tour system, wherein audio provided from the base unit is played at the remote units and data from the base unit performs control functions at the remote unit. Interactive system 10 may be a paging system in which audio capabilities are superimposed upon paging data. Other applications may be apparent to the skilled artisan.

For the purpose of a complete disclosure, wireless audio and data interactive system 10 is disclosed in the embodiment of a learning laboratory. In such system, the base unit is operated by a teacher or monitor and may be referred to as a teacher or instructor unit. The remote units are provided to students and may be referred to as student units. A plurality of audio channels are provided to supply pre-recorded material to the student units. Any student unit can listen to any active lesson channel either by the choice of the student or, if the capability is provided, by the choice of the teacher. One or more of the audio channels may be used as a common intercom channel. A remote unit 14 may be connected to the intercom channel if data from the base unit instructs it to. Audio sources for the lesson channels may include cassette, CD, VCR, DVD, computer, etc. Also, in the illustrative embodiment, each student unit is a battery-operated unit in order to enhance its portability function. However, the manner in which the student unit is powered is not directly related to the invention. The base unit may be in the form of a piece of furniture that contains an instructor control and audio sources for the learning laboratory or may take other forms, such as a desktop unit, portable unit, or the like. The base unit is the central electronics assembly.

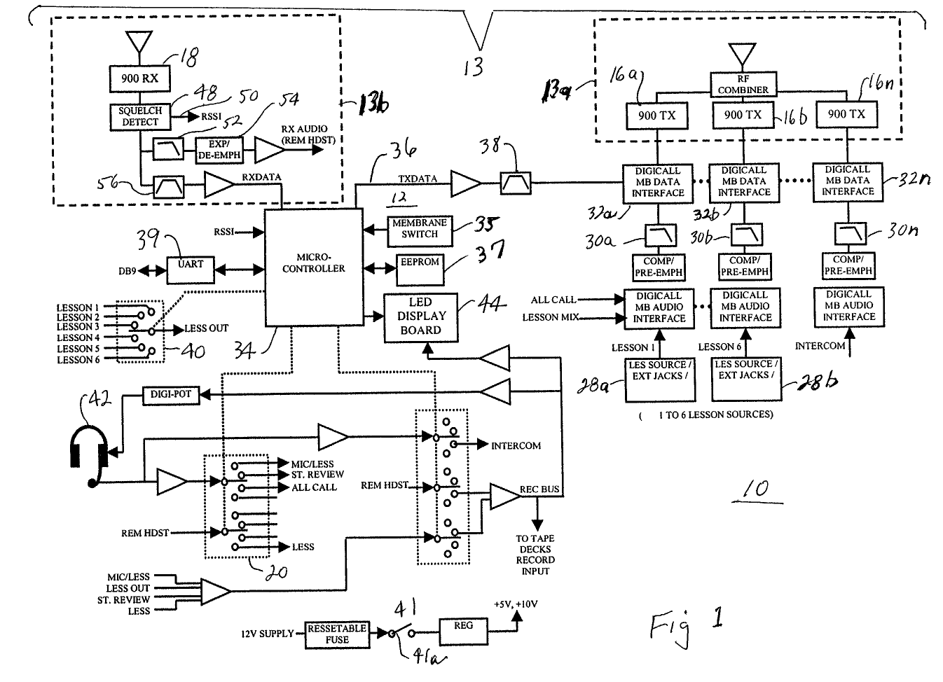

Base unit 12 has a unidirectional transmission channel that transmits to each student's student unit (FIG. 1). The base unit 12 includes a transceiver 13, which provides bidirectional communication with each student unit 14. Transceiver 13 may be an integral unit or may have a separate transmitter assembly 13a and receiver assembly 13b. Transmitter assembly 13a is illustrated by transmitters 16a, 16b . . . 16n. Transmitters 16a-16n provide a lesson link to transmit audio signals, principally in the form of pre-recorded audio from tape, CD, computer, and the like, as well as an intercom link that is common to all, or a group of, students. Transmitter assembly 13a , in the illustrative embodiment, transmits up to four combined audio and data signals to the student receivers. Transmitter assembly 13a, in the illustrative embodiment, can be used to transmit up to seven individual channels. These numbers are exemplary only and a greater or fewer number can be used.

Receiver assembly 13b receives either an audio signal, or a combined audio and data signal, from the student units primarily for the purpose of the instructor monitoring student's speech and participation, as well as allowing a two-way conversation between the instructor and the student. Receiver assembly 13b is illustrated with a single receiver, although two receivers can be configured to operate in diversity, if desired, to improve signal coverage. One or both receivers 18 can be configured to also receive student data, which can include operating information, such as battery life, other parametric information, such as test results, and also button presses and other information about student interaction. A monitor link 18 is illustrated as a receiver for the teacher unit to receive audio signals back from a selected student's unit over a common channel, also known as monitor channel. Such audio signal may be in the form of the student's mimicking the speech in the lesson, responding to questions in the lesson, translating language in the lesson, and the like. The monitor channel may also feed back to the instructor the audio that the student is hearing and responding to. Data from the base unit may be used to switch the transmitter of the selected student unit to provide such intercom and monitor function, but can also be used to operate data displays, and the like.

Referring to FIG. 1, base unit 12 includes one or more pre-recorded audio source 28a-28n that is supplied through a low-pass filter 30a-30n to an interface 32a-32n. These sources can consist of permanently installed cassette recorders and CD players or stand-alone commercial audio sources, such as VCRs, multiple CD players, computers, and the like. The source of audio may be conditioned for optimum quality for transmission to the students. Data from a microcomputer 34 is supplied through a channel 36 that is common to all student units and is supplied through a band-pass filter 38 to interfaces 32a-32n. This data stream is transmitted from the microcontroller 34 for the purpose of sending commands and data to the student receivers 14. In the illustrative embodiment, the data stream is an OOK (ON/OFF Keyed) subcarrier that may be filtered and conditioned for optimal performance before being summed with the outgoing lesson and intercom audio at interfaces 32a-32n. Interfaces 32a-32n combine the data on data channel 36 with the analog audio signal from the respective audio source 28a-28n and modulate the respective transmitters 16a-16n in order to send the combined data and audio signal to the respective student unit 14. In the illustrated embodiment, low-pass filters 30a-30n are active high Q filters having a cutoff of 7 kHz. In the illustrative embodiment, band-pass filter 38 is also an active high Q filter having a cutoff on the low end of approximately 13 kHz. This prevents the audio from being corrupted by the data at the student unit. Also, it reduces peaks in the audio signal from being perceived at the student unit as data.

The base unit, or teacher/instructor unit, also includes a controller 40 that allows the teacher/monitor to monitor a particular student unit. Also, the teacher/instructor unit includes a headset 42 for communicating with individual student units, both for monitoring the speech of the student, as well as carrying on a two-way conversation with a particular student and listening to what is being transmitted on 16a-16n , i.e., what the student is going to receive before it is sent. This allows the teacher/instructor to adjust audio levels, and the like. Headset 42 also contains a microphone to communicate directly with the entire class, a portion of the class, or individual students. A second headset (not shown) may be provided for the purposes of a guest instructor, or the like. A display board 44 provides information to the teacher/monitor. A universal asynchronous receiver transmitter (UART) 39 provides communication between microcontroller 34 and a computer (not shown) to provide a flow of data through channel 36 to the student units, as well as to receive data back from the student units. Microcontroller 34, in the illustrative embodiment, is a PIC16C65A processor that controls all audio and data functionality. It receives input from a switch, such as a membrane switch 35. Microcontroller 34 also interconnects with an EEPROM 37, which contains data saved when the power is removed. Microcontroller 34 sends data to a display board 44, EEPROM 37, UART 39, and transmitter assembly 13a for sending to the student transceivers, as well as to audio switching and volume control circuitry.

Signals received by the base unit from monitor link 18 may go through a squelch detect 48, if necessary. Squelch detect 48 is software and hardware that decreases amplifier gain if the signal goes away in order to prevent white noise from reaching the instructor. Squelch detect 48 responds to a received signal strength indicator signal 50, which provides an indication of the strength of the signal, received. The received signal goes through a low-pass filter 52 to extract audio signals from the received signal. The audio signals may be sent to an expander and/or de-emphasis the circuit, if necessary. The audio signal is then supplied through audio control circuitry 20 to the teacher/monitor headset 42. This and other circuitry are under the control of microcontroller 34. Microcontroller 34 switches the instructor's voice and the various sources of lesson audio to the appropriate transmitter. It also receives audio from the receiver assembly 13b and directs it to the teacher/monitor. Audio control circuitry 20 may also provide the capability to record audio programs for future retrieval. The received signal is also passed through a band-pass filter 56 which separates the digital data from the audio and supplies the data signal to microcontroller 34. The data may be processed by microcontroller 34 and utilized at teacher console 12 or supplied through computer interface 39 to another computer for further processing. Power supply circuitry 41 takes in external voltage input and generates individual DC supplies for the digital and audio circuitry of monitor unit 12. The external DC input may be switched ON or OFF with a switch 41a by the instructor.

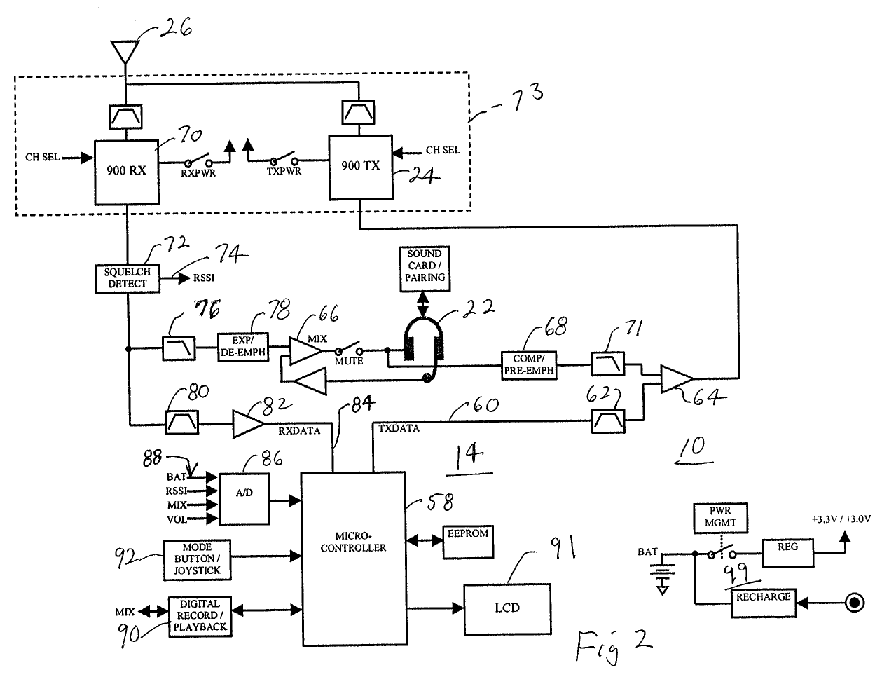

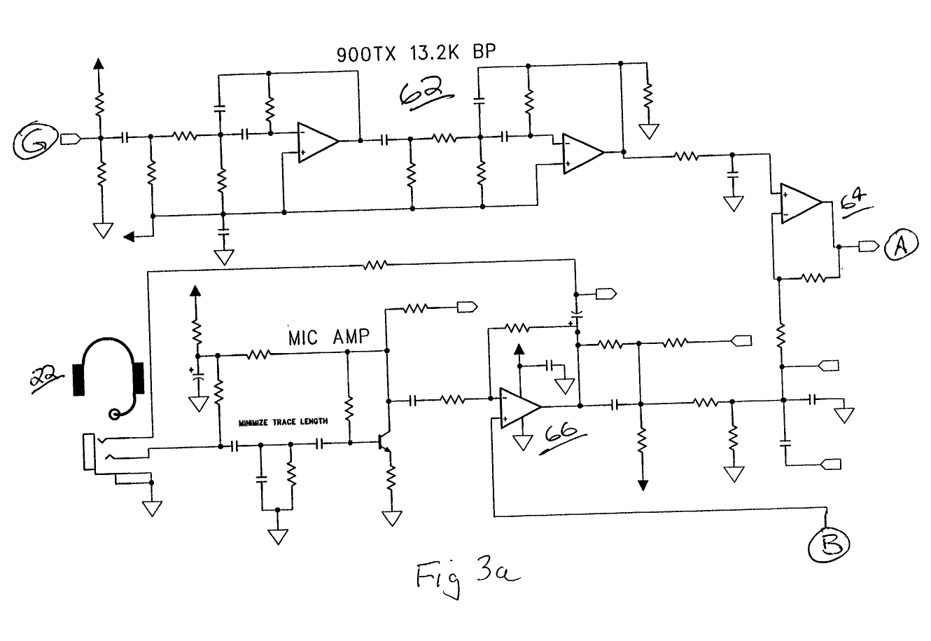

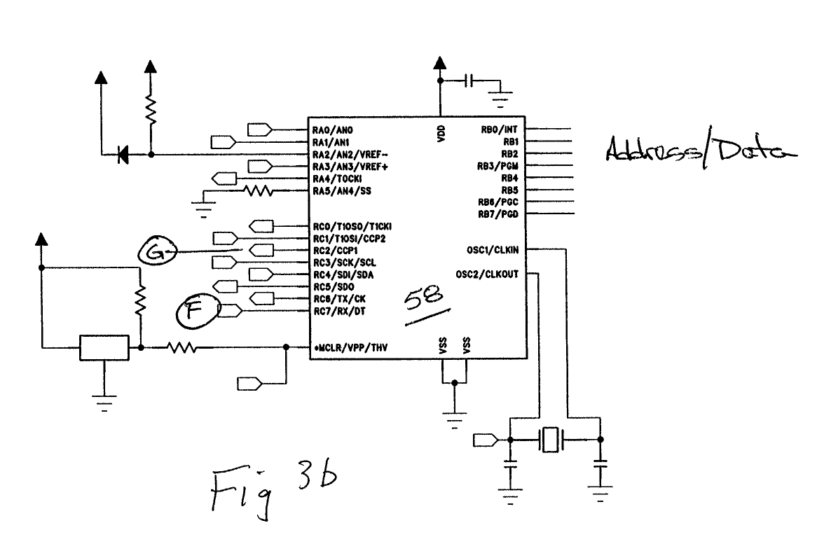

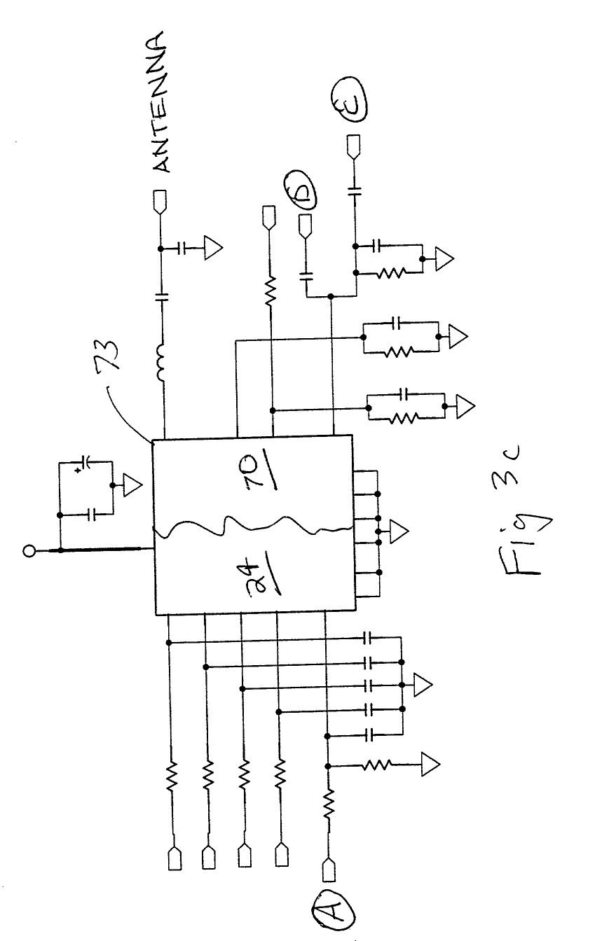

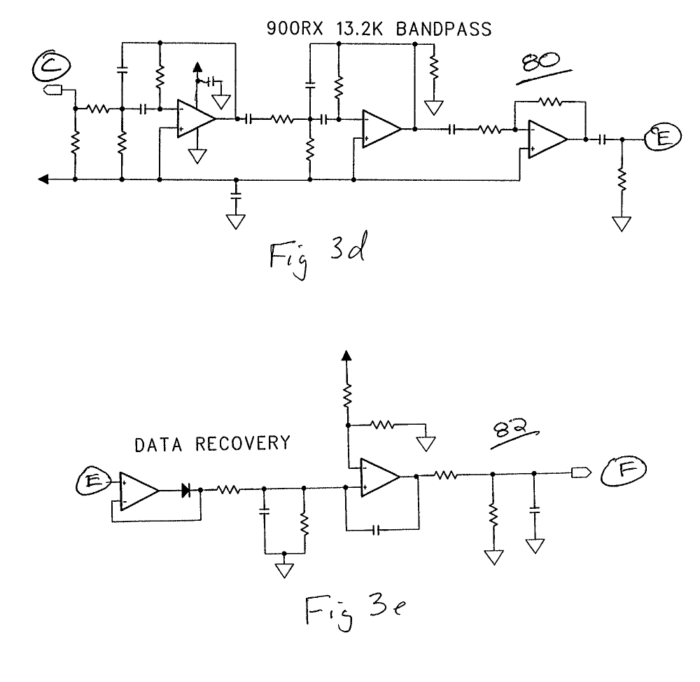

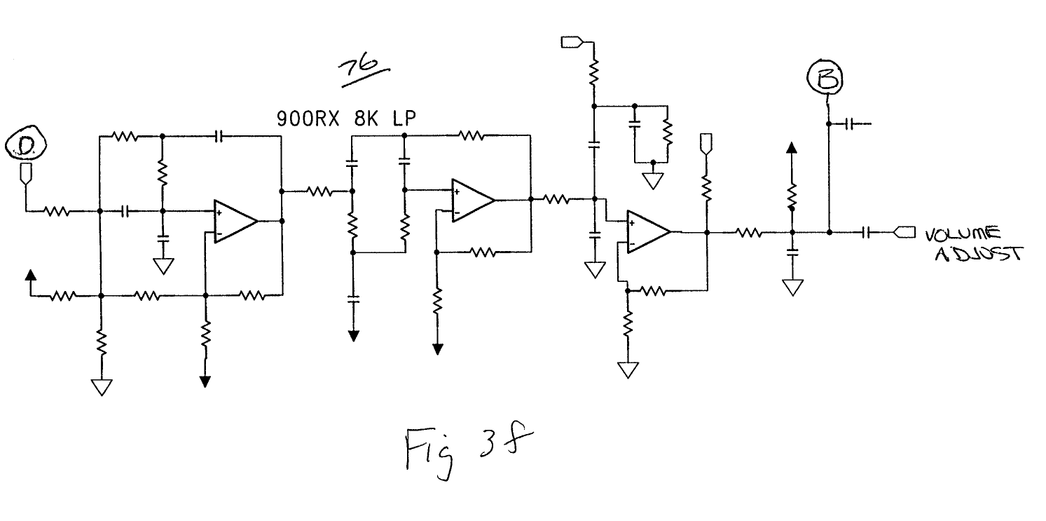

Each remote unit, or student unit, 14 includes a headphone 22 for use by the student in receiving lessons from base unit 12, as well as a microphone for receiving the audio sounds made by the student (FIGS. 2 and 3a-3f). A transmitter 24, which is under the control of the base unit 12, allows the student unit to be connected to the monitor link in response to digital data combined with audio sent from the base unit to the remote units. The same data stream may be sent to all students. Alternatively, separate data streams may be provided to different students. In the illustrative embodiment, a single monitor channel is used. It should be understood that more than one monitor channel may be provided. Indeed, in some applications, a monitor link may be permanently provided with each lesson link.

Each student unit 14 includes a transceiver 73 which is an RF circuit having receiving portion 70 and transmitting portion 24 connected with an antenna 26. The receiver portion 70 receives audio and data from the lesson or intercom portion of the base unit. Receiver portion 70 may be tuned to one of the lesson link or intercom transmitters 16a-16n. In this manner, each student unit may receive pre-recorded audio input or teacher dialog that is the same as or different from other student units. Receiver portion 70 is normally activated 100 percent of the time that a student is using it. Transmitter portion 24 sends audio and data to the base unit. It is switched on by a microcontroller 58 when a command is received from the base unit telling it to do so. This normally happens when an instructor wants to receive remote unit audio, such as in order to listen to that student. This may also happen when student unit 14 sends data alone or a combined remote unit audio and data signal.

Microcontroller 58, in the illustrative embodiment, is a PIC16LF873 processor that controls all audio and data functionality. It receives input from an input 92, such as a button, joystick, or the like, and from receiver 70. Microcontroller 58 may also receive an analog/digital input 86, which measures various audio levels, signal strength, and battery strength, as well as various onboard peripherals. Microcontroller 58 sends data, which may be received from the base unit to an LCD display 91 to provide feedback to the student. Microcontroller 58 also sends outputs to transmitter portion 24, as well as other onboard peripherals.

Microcontroller 58 may have a data output 60 that is supplied through a band-pass filter 62 to a combiner circuit 64. Signals from the microphone of headset 22 are mixed at 66 with audio signals received with receiver 70 to a low-pass filter 71 for combination at combiner 64 with the data. The signals may be supplied through a pre-emphasis and/or compressor circuit, if necessary. The combined audio and data signals are transmitted by transmitter 24 on the monitor channel provided that the particular student unit is connected to the monitor link.

A student headset 22 includes one or more speakers that allow the student to listen to intercom and lesson audio. It also contains a microphone for the purpose of speaking along with and transmitting audio to the monitor unit. A second audio jack may be available for sending and receiving audio from other student headsets or an external playback and record device, such as a cassette deck or computer soundcard.

Receiver portion 70 supplies a single signal containing both audio and digital data. The audio is extracted using a filter 76 and may be optimized using algorithms under the control of microcontroller 58. Data is extracted and conditioned using band-pass filter 80 as digital levels for the microcontroller 58. Audio is sent to transmitter portion 24 and is mixed with conditioned digital information supplied by the microcontroller with combiner circuit 64.

Combined audio and data signals received by receiver 70 are decoded by a receiver 70 supplied to a squelch detect circuit 72 which uses a receiver signal strength indication 74. The output of squelch detect circuit 72 is supplied through a low-pass filter 76 to mixer 66 for supplying to the headphones 22 as an audio signal. The output of squelch detector circuit 72 is also supplied through a band-pass filter 80 and an amplifier and conditioning circuit 82 as an input 84 to microprocessor 58. Input 84 is a data channel. The output of squelch detector 72 may be put through an expander and the de-emphasis circuit 78, if necessary.

An analog-to-digital converter 86 receives various inputs 88 and converts the inputs to digital signals for microcomputer 58. Microcomputer 58 may, in turn, utilizes the input supplied to A/D converter 86 to supply data over monitor link 24 to the teacher console 12, as well as for control and display purposes. The student unit may also send data back to the teacher console representative of battery strength, received signal strength indicator and volume set by the student. In addition, a port 90 may be provided for supplying information to an external unit. As well, an external input (MIX) may be supplied to an audio circuit and A/D converter 86 to allow a software-controlled VU meter to display audio amplitude at the student unit or allow the student to listen to and talk to external computers, recorders, or the like.

A power supply circuitry 99 may operate with batteries and contains a step-up switching regulator that generates a DC voltage. The supply is then conditioned and used to power the various audio and digital circuitry. The switch is always powered on, but only draws significant current when initiated by pressing either the button or joystick 92. The supply then stays on until the student turns the unit off, data is no longer being received from the monitor unit, or a programmable timer expires indicating that the unit has been inactive for too long.

Student unit 14 may optionally include a keypad, or joystick, or other input devices, 92 in order to allow the student to answer questions, such as Yes/No questions, multiple-choice questions or to supply text utilizing the unique capabilities of the present invention to supply data in combination with the audio, utilizing the principles disclosed in commonly assigned U.S. Pat. Re. Nos. 35,449; 5,724,357; and 6,021,119, the disclosures of which hereby incorporated herein by reference.

Student unit 14 may optionally be equipped with a switch (not shown) that allows a data only channel to be connected to monitor link 24. Because the data signals on the data only channel do not have to be combined with audio in the data only mode, a wideband band-pass filter may be utilized. It should be understood that a data only channel is optional.

Prior to being combined with the audio, data may be passed through a bandpass filter. The analog audio signal may be supplied through a low-pass filter that removes frequencies preferably above audio range, such as above 5 kHz, above approximately 7 kHz, or the like. The data and audio are separated at the received end by utilizing low-pass filters to remove the audio signal and band-pass filters to separate out the data signal. The band-pass filters may be 4 or 5 pole filters and may be a high quality, high Q, band-pass filter that eliminates signals below a particular frequency, such as 10 kHz, 20 kHz, 40 kHz, or the like. Preferably, an RF link from the teacher/monitor console to each student unit operates at a first frequency, and a common RF link from the students' units to the teacher/monitor console operates at a different frequency. The frequencies may be in the range of approximately 902 to 928 MHz. In the illustrated embodiment, the monitor communication link from the teacher/monitor console to each student unit may be selected from a range of 902 to 908 MHz. The intercom common channel from the teacher/monitor units to the student units may be selected from a range of 921 to 928 MHz. The lesson channel may also be selected from a range of 921 to 928 MHz. Although the illustrated embodiment is a radio frequency (RF) communication system in the 900 MHz band, other bands, as well as other wireless techniques, such as infrared, and the like, may be utilized.

Details of the circuits used in student unit 14 are illustrated in FIGS. 3a-3f, similar circuits being utilized in the teacher console 12. Channels are selectable under software control. Transmitter 24 receives an input from mixer 64, which, in turn, receives inputs from low-pass filter 71 and band-pass filter 62. Receiver 70 produces an output RXDEMOD that is supplied to band-pass filter 80 and to low-pass 76. The output of band-pass filter 80 goes to a data recovery circuit in order to convert the 13 kHz signals to individual bits that can be input directly to microcontroller 58.

The ability to combine audio and data channels allows the base unit to turn on a student's transmitter, to switch a student's unit to an intercom channel or monitor channel, or any one of many other functions, without the requirement for a separate data channel. Also, the data may be used to allow the monitor to command a student unit to select a particular lesson channel. Moreover, new functions previously impractical are possible. For example, the student units may return data to the teacher/monitor console. Such data may include status of the student's unit, which is typically battery operated. It may also send signals, such as the signal strength of the signal received by the student unit (receiver signal strength indicator). It may additionally send statistical data, such as how many incorrect answers the student gave, and the like.

In another application, the ability to return text with analog audio may be exploited with a voting keypad combined with the student unit in order to allow the student to provide Yes/No answers or to select a particular multiple-choice answer or, otherwise, supply text and other information to the teacher/monitor console. This may be accomplished utilizing the principles disclosed in commonly assigned U.S. Pat. Re. Nos. 35,449; 5,724,357; and 6,021,119, the disclosures of which are hereby incorporated herein by reference. Additionally, the teacher/monitor console could provide acknowledge data to the student unit, acknowledging receipt of valid signals from the particular student unit. Additionally, configuration data, unique packets of data, could be downloaded to one or more student units in order to provide permanent settings to the student units. In keeping with this principle, it may be possible to provide identifying bits preceding each packet of data sent to the student unit or units in order to identify the nature of the data that is being sent. This will allow the student unit to distinguish between data that is to be permanently stored in the student unit versus other types of data.

The nature of the data that can be sent from the teacher/monitor console to the student unit and from the student unit to the teacher/monitor console is exemplary only. The skilled artisan will devise other types of data that may be transmitted. All such data is intended to be encompassed by the present invention, which provides the ability to transmit such data along with audio signals without the requirement for separate data channels.

Having described the invention in the embodiment of a wireless learning laboratory, the manner in which the invention could be embodied in other applications, such as those set forth above, would be apparent to those skilled in the art.

Changes and modifications in the specifically described embodiments can be carried out without departing from the principles of the invention.

The embodiments of the invention in which an exclusive property or privilege is claimed are defined as follows:

1. An audio and data interactive system, comprising:
at least one base unit having a first microcomputer-based control and a first wireless transceiver;
at least one remote unit having a second microcomputer-based control, a speaker system and a second wireless transceiver;
said first control combining digital data with at least one audio signal within human hearing range in a combined digital data and audio signal and supplying the combined digital data and audio signal to said first transceiver;
said second control separating the combined digital data and audio signal from said second transceiver into the digital data and the audio signal;
said second control supplying the audio signal to said speaker system; and
said second control causing said second wireless transceiver to transmit in response to the digital data.

2. The system of claim 1 wherein said speaker system includes a headphone.

3. The system of claim 2 wherein said second control causes said second wireless transceiver to transmit remote unit audio in response to the digital data.

4. The system of claim 1 wherein said first and second transceivers define a plurality of audio channels between the at least one remote unit and the at least one base unit.

5. The system of claim 4 wherein said second control of said at least one student unit connects the corresponding speaker system to one of said audio channels in response to said digital data.

6. The system of claim 4 wherein said at least one of said audio channels defines at least one intercom channel between the base unit and the remote units, said at least one intercom channel providing communication between the at least one base unit and said at least one remote unit.

7. The system of claim 6 wherein said second control of at least one of said student units connects the corresponding speaker system to said at least one intercom channel in response to said digital data.

8. The system of claim 4 wherein at least one of said audio channels defines a content channel, said content channel conveying content to the at least one remote unit.

9. The system of claim 8 wherein said at least one audio signal is selected from at least one of (i) an output of a headphone and (ii) pre-recorded material.

10. The system of claim 1 wherein said first and second transceivers define at least one monitoring channel between said at least one remote unit and said at least one base unit, said monitoring channel allowing the at least one base unit to monitor audio generated at said at least one remote unit.

11. The system of claim 10 wherein said second control causes said second wireless transceiver to transmit audio generated at the associated remote unit in response to said digital data.

12. The system of claim 1 wherein said second control causes said second wireless transceiver to transmit remote unit audio in response to said digital data.

13. The system of claim 1 wherein said base unit includes another speaker system to convert audio generated at said at least one remote unit to human perceptible audio.

14. The system of claim 1 wherein said second control combines additional digital data with audio generated at said at least one remote unit in a combined additional digital data and remote unit audio signal and supplies the combined additional digital data and remote unit audio signal to said second transceiver, and wherein said first control separates the combined additional digital data and remote unit audio signal from said first transceiver into the additional digital data and the remote unit audio signal.

15. The system of claim 14 wherein said additional digital data conveys information selected from at least one of (i) remote test performance, (ii) strength of the signal received by the remote unit, and (iii) status of operation of the remote unit.

16. The system of claim 14 wherein said base unit includes another speaker system to convert the remote unit audio output signal to human perceptible audio.

17. The system of claim 16 wherein said base unit includes a microphone.

18. The system of claim 17 wherein said at least one audio signal is selected from at least one of (i) an output of said another microphone and (ii) pre-recorded lesson material.

19. A wireless audio and data interactive method, comprising:
providing at least one base unit having a first microcomputer-based control and a first wireless transceiver;
providing at least one remote unit having a second microcomputer-based control, a speaker system and a second wireless transceiver;
combining digital data with at least one audio signal within human hearing range in a combined digital data and audio signal and supplying the combined digital data and audio signal to said first transceiver;
separating the combined digital data and audio signal from said second transceiver into the digital data and the audio signal;
supplying the separated audio signal to said speaker system; and
causing said second wireless transceiver to transmit in response to the separated digital data.

20. The method of claim 19 wherein said speaker system includes a headphone.

21. The method of claim 20 including selectively transmitting remote unit audio in response to the digital data.

22. The method of claim 19 including defining a plurality of audio channels between the at least one remote unit and the at least one base unit with said first and second transceivers.

23. The method of claim 22 including connecting the corresponding speaker system of said at least one remote unit to one of said audio channels in response to said digital data.

24. The method of claim 22 wherein at least one of said audio channels defines at least one intercom channel between the at least one remote unit and the at least one base unit with said first and second transceivers and providing communication between the base unit and the corresponding remote unit with said at least one intercom channel.

25. The method of claim 24 including connecting the corresponding speaker system of at least one of said remote units to said at least one intercom channel in response to said digital data.

26. The method of claim 22 wherein at least one of said audio channels defines a content channel, said content channel conveying content to the at least one remote unit.

27. The method of claim 26 wherein said content is selected from at least one of (i) an output of a headphone and (ii) pre-recorded material.

28. The method of claim 19 including defining at least one monitoring channel with said first and second transceivers between the at least one remote unit and the at least one base unit and monitoring audio generated at said at least one remote unit with said monitoring channel.

29. The method of claim 28 including causing said second transceiver of said at least one remote unit to transmit remote unit audio on said monitoring channel in response to said digital data.

30. The method of claim 19 including causing said second wireless transceiver to transmit remote unit audio in response to said digital data.

31. The method of claim 19 including providing another speaker system at said base unit to convert the remote audio output signal to human perceptible audio.

32. The method of claim 19 including combining additional digital data with audio generated at said at least one remote unit in a combined additional digital data and remote unit audio signal and supplying the combined additional digital data and remote unit audio signal to said second transceiver, and further separating the combined additional digital data and remote unit audio signal from said first transceiver into the additional digital data and the remote unit audio signal.

33. The method of claim 32 wherein said additional digital data includes information selected from at least one of (i) data on remote test performance, (ii) strength of signal received by the remote unit, and (iii) status of operation of the remote unit.

34. The method of claim 32 including providing another speaker system with said base unit and converting the remote unit audio output signal to human perceptible audio with said another speaker system.

35. The method of claim 34 wherein said another speaker system includes a headphone.

36. The method of claim 35 including selecting said at least one audio signal from at least one of (i) an output of said headphone and (ii) pre-recorded material.

37. An audio and data interactive system, comprising:
at least one base unit having a first microcomputer-based control and a first wireless transceiver;
at least one remote unit having a second microcomputer-based control, a speaker system and a second wireless transceiver;
said first control combining digital data with at least one audio signal within human hearing range in a combined data and audio signal, and supplying the combined data and audio signal to said first transceiver;
said second control separating the combined data and audio signal received by said second transceiver into the digital data and the audio signal;
said second control supplying the audio signal to said speaker system;
said second control combining additional digital data with a remote unit audio in combined additional digital data and remote unit audio signal and supplying the combined additional digital data and remote unit audio signal to said second transceiver; and
said first control separating the combined additional digital data and remote unit audio signal from said first transceiver into additional digital data and remote unit audio signal.

38. A wireless audio and data interactive method, comprising:
providing at least one base unit having a first microcomputer-based control and a first wireless transceiver;
at least one remote unit having a second microcomputer-based control, a speaker system and a second wireless transceiver;
combining digital data with at least one audio signal within human hearing range and supplying the combined data and audio signal to said first transceiver;
separating the combined data and audio signal from said second transceiver into the digital data and the audio signal;
supplying the separated audio signal to said speaker system;
combining additional digital data with remote unit audio in a combined additional data and remote unit audio signal and supplying the combined additional data and remote unit audio signal to said second transceiver; and
separating the combined additional data and remote unit audio signal into the additional digital data and the remote unit audio signal.
